(19) United States
(12) Patent Application Publication
(10) Pub. No.: US 2011/0109597 A1
(43) Pub. Date: May 12, 2011

(54) DISPLAY DRIVER, METHOD OF OPERATING THE SAME, AND DISPLAY DEVICE INCLUDING THE SAME

(75) Inventor: Sang Hun KIM, Seoul (KR)

(73) Assignee: Samsung Electronics Co., Ltd, Suwon-si (KR)

(21) Appl. No.: 12/881,394

(22) Filed: Sep. 14, 2010

(30) Foreign Application Priority Data
Nov. 6, 2009 (KR) 2009-0106712

(51) Int. Cl. G06F 3/038

(52) U.S. Cl. 345/204

(57) ABSTRACT

A display driver to output blanking data to a display panel in response to a hardware reset signal applied while image data is being displayed on the display panel. Additionally, a method of operating a display driver includes supplying image data to a display panel, and supplying blanking data to the display panel in response to a reset signal applied while the image data is being supplied to the display panel.

### CROSS-REFERENCE TO RELATED APPLICATIONS

This application claims priority under 35 U.S.C. §119(a) from Korean Patent Application No. 10-2009-0106712, filed on Nov. 6, 2009, in the Korean Intellectual Property Office, the disclosure of which is incorporated herein in its entirety by reference.

### BACKGROUND

1. Field of the Invention

The present general inventive concept relates to display drivers, and more particularly, to a display driver capable of removing an afterimage from a display panel, a method of operating the display driver, and a display device including the display driver.

2. Description of the Related Art

When a hardware reset signal is applied while image data is being displayed on a display panel, all signals are initialized without undergoing display off and power off. Thus, an afterimage may be generated on the display panel or a display driver enters into a spontaneous unstable state, so that leakage may occur.

### SUMMARY

Additional features and utilities of the present general inventive concept will be set forth in part in the description which follows and, in part, will be obvious from the description, or may be learned by practice of the present general inventive concept.

According to a feature of the present general inventive concept, there is provided a method of operating a display driver, the method including supplying image data to a display panel, and supplying blanking data to the display panel in response to a reset signal applied while the image data is being supplied to the display panel.

The blanking data is supplied to the display panel for a predetermined number (N) of frames in response to a blanking enable signal generated in response to the reset signal, wherein N denotes a predetermined natural number. The blanking data is a set of data having identical voltage levels. The method further includes supplying sleep data to the display panel, after supplying the blanking data to the display panel.

According to another feature of the present general inventive concept, there is provided a display driver including a gate driver, and a source driver to display image data on a display panel together with the gate driver. The source driver supplies blanking data to the display panel in response to a reset signal applied while the image data is being supplied to the display panel.

The source driver supplies the blanking data to the display panel for a predetermined number (N) of frames in response to a blanking enable signal generated in response to the reset signal, wherein N denotes a natural number. The display driver further includes a finite state machine (FSM) capable of being initiated in response to a power-on reset signal and controlling an operation of the source driver and an operation of the gate driver.

The display driver further includes a display control register capable of being initiated in response to a power-on reset signal or a first reset signal and controlling an operation of the source driver and an operation of the gate driver, and a power control register capable of being initiated in response to the power-on reset signal or the first reset signal and control supply of power to at least one of the source driver, the gate driver, and the display panel.

The display driver further includes an AND gate to receive a second reset signal generated after the blanking data is supplied to the display panel and a hardware reset signal, and a selector to output an output signal of the AND gate or a high level signal to serve as the first reset signal, in response to a display state indicating signal.

The selector outputs the output signal of the AND gate or the high level signal to serve as the first reset signal, in response to the display state indicating signal that indicates whether the blanking data has been completely supplied to the display panel.

According to another feature of the present general inventive concept, there is provided a display device including a display panel, and a display driver to supply data to the display panel. The display driver supplies blanking data to the display panel for a predetermined number (N) of frames in response to a reset signal generated in a display-on state.

According to another feature of the present general inventive concept, there is provided a display system including a display device, and a processor to control an operation of the display device. The display device includes a display panel, and a display driver to supply data output from the processor to the display panel. The display driver supplies blanking data to the display panel in response to a reset signal output from the processor in a display-on state.

The display driver supplies the blanking data to the display panel for a predetermined number (N) of frames in response to a blanking enable signal generated in response to the reset signal, wherein N denotes a natural number. The display driver supplies sleep data to the display panel after supplying the blanking data to the display panel.

In another feature of the present general inventive concept, a display device comprises a display panel operable in a display-on state and non display-on state and including a plurality of data lines and a plurality of gate lines to intersect the plurality of data lines to form a plurality of pixels, a source driver to supply blanking data to the display panel in response to a reset signal generated in a display-on state, and a capacitor formed in each pixel among the plurality of pixels of the display panel to store the blanking data.

In yet another feature of the present general inventive concept, a method of operating a display device including a display having a plurality of pixels comprises displaying an image on the display via the pixels, generating blanking data including identical voltage levels, storing the blanking data in the pixels while the image is displayed, outputting the blanking data to the pixels to remove the displayed image for a predetermined number (N) of frames, and inhibiting power to the display after outputting the blanking data.

In still another feature of the present general inventive concept, a display driver operable in a non-display mode and a display mode to drive images displayed on a display panel includes a source driver to output image data to the display panel, a gate driver to drive the display panel, a display module to control the source driver and the gate driver in response to an active reset signal, and a reset control module to detect the non-display mode and the display mode and that outputs an inactive reset signal in response to detecting the non-display mode and that outputs the active display signal in response to detecting the display mode.

### BRIEF DESCRIPTION OF THE DRAWINGS

The above and/or other features of the present general inventive concept will become apparent and more readily appreciated from the following description of the exemplary embodiments, taken in conjunction with the accompanying drawings, in which:

FIG. 1 is a block diagram of a display system according to an exemplary embodiment of the present general inventive concept;

FIG. 2 is a timing diagram of control signals to control an operation of a display driver of the display system illustrated in FIG. 1, when a hardware reset signal is applied in a state other than a display-on state;

FIG. 3 is a timing diagram of control signals to control an operation of the display driver of the display system illustrated in FIG. 1, when the hardware reset signal is applied in the display-on state;

FIG. 4 is a timing diagram of data output from the display driver of FIG. 1 to a display panel of the display system illustrated in FIG. 1 and the control signals to control the operation of the display driver of FIG. 1, when the hardware reset signal is applied in the display-on state; and

FIG. 5 is a flowchart of an operation of the display system illustrated in FIG. 13

### DETAILED DESCRIPTION OF THE EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

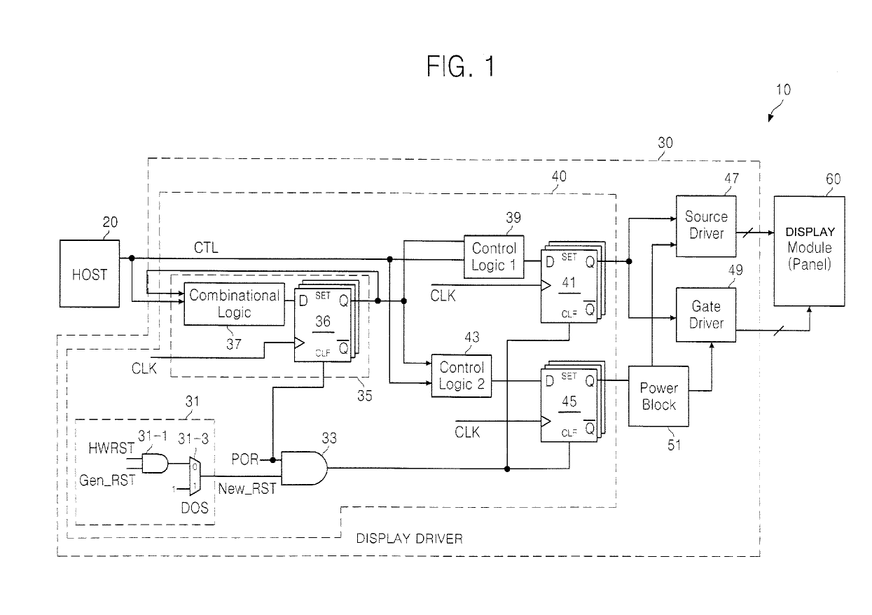

FIG. 1 is a block diagram of a display system 10 according to an exemplary embodiment of the present general inventive concept. Referring to FIG. 1, the display system 10 may include a host 20, a display driver 30, and a display panel (or a display module) 60.

The display system 10 may be a personal computer (PC), a notebook PC, a net-book, a personal digital assistant (PDA), a portable multimedia player (PMP), an e-book, a mobile communication device such as a mobile phone or a smart phone, or any of various display devices each including a display panel having a plurality of pixels to display image data.

The host 20 may be implemented into a processor such as a central processing unit (CPU) and may output a plurality of control signals CTRL and/or commands to control an operation of the display driver 30. The display driver 30 includes a timing controller 40, a source driver 47, a gate driver 49, and a power supply block 51. The display driver 30 may be manufactured into a single chip and packaged. Alternatively, the timing controller 40, the source driver 47, and the gate driver 49 may be manufactured into different chips, respectively.

The display driver 30 may supply blanking data to the display panel 60 over an interval of N (where N denotes a natural number) frames in response to a hardware reset signal HWRST output from the host 20 while supplying image data to the display panel 60. The image data may be output from the host 20 and may include data to display a still image and/or a moving image on the display panel 60. The blanking data may denote data set having identical voltage levels, for example, minimum or maximum voltage levels from among a plurality of grayscale voltages.

The timing controller 40 may include a reset control circuit 31, a reset signal generation circuit 33, a finite state machine (FSM) 35, a first control logic 39, a display control register 41, a second control logic 43, and a power control register 45.

Although the timing controller 40 is separated from a source driver 47 or a gate driver 49 in FIG. 1, at least a part of the timing controller 40 may be formed in the source driver 47 or the gate driver 49.

While the display panel 60 operates in a display-on state, i.e., a state to display a still image, a moving image, and/or a blanking display, when the hardware reset signal HWRST generated from the host 20 is received while the image data is being supplied to the display panel 60, the timing controller 40 may initiate the display control register 41, which is capable of controlling operations of the source driver 47 and the gate driver 49. The timing controller 40 may also control the power control register 45, which is capable of controlling an operation of the power supply block 51, in response to the hardware reset signal HWRST or a first reset signal New_RST.

The reset control circuit 31 may receive a hardware reset signal HWRST and a display state indicating signal (DOS), which indicates a display state of the display panel 60, from the host 20, and may output an output signal from the AND gate 31-1, i.e., a high level signal, for example, data 1, as the first reset signal New_RST, based on the hardware reset signal HWRST output from the host 20 and the display state indicating signal (DOS). The high level signal output from the AND gate 3101 may denote a power supply voltage.

The DOS signal may operate in a high level when the display panel 60 operates in a display-on state, and may operate in a low level when the display panel 60 operates in a non display-on state. The display-on state may include a normal display state where still-images and/or moving images are displayed on the display panel 60, and/or a blank display state where blanking data is supplied to the panel display. The non display-on state may include a power-on state, where power is supplied to the display panel 60 without displaying an image, and a sleep-in state, where power to the display panel 60 is inhibited.

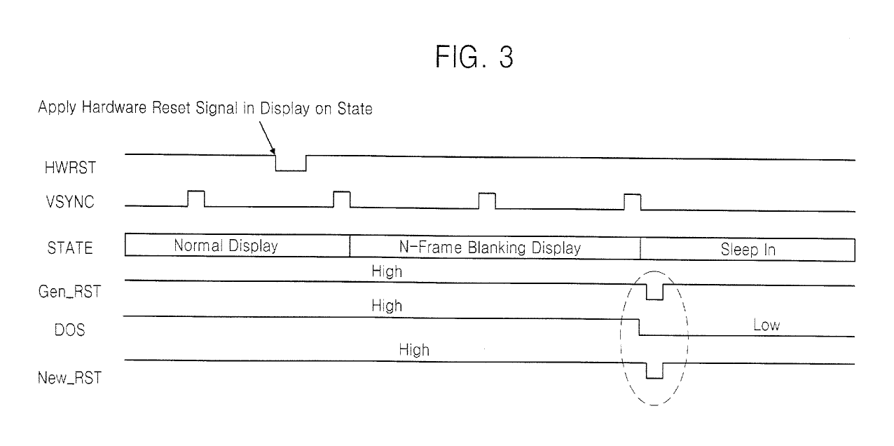

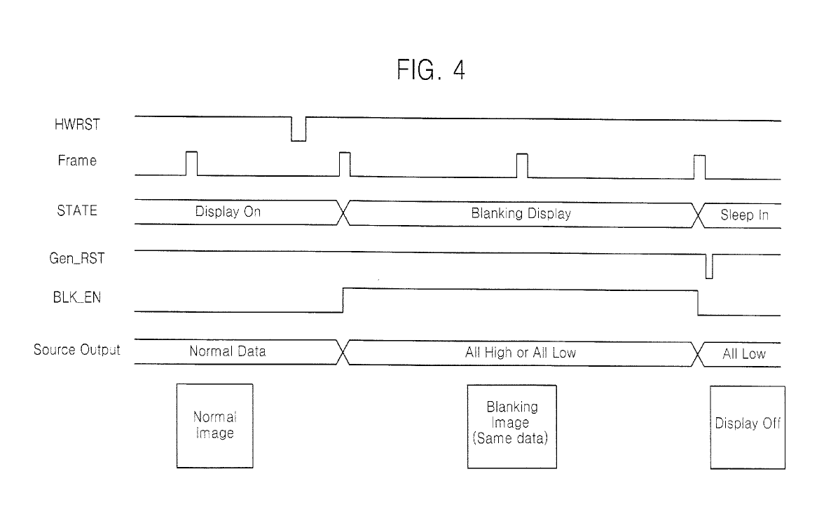

More specifically the reset control circuit 31 includes an AND gate 31-1 and a selector 31-3. The AND gate 31-1 receives the hardware reset signal HWRST and a second reset signal Gen_RST from the host 20, performs a logic operation on the hardware reset signal HWRST and the second reset signal Gen_RST, and outputs a result of the logic operation, i.e., high level data 1 signal. The second reset signal Gen_RST is output after blanking data has been supplied to the display panel 60 for a predetermined number (N) of frames, which is generated when the hardware reset signal HWRST is output while image data is being supplied to the display panel 60, i.e., while the display panel 60 is operating in a display-on state, as illustrated in FIGS. 3 and 4.

The selector 31-3 outputs the output signal of the AND gate 31-1, i.e., the high level, for example, the data 1, as the first reset signal New_RST based on the display state indicating signal (DOS). The selector 31-3 may be implemented as a multiplexer.

When the hardware reset signal HWRST output from the host 20 is received by the reset control circuit 31 while the display driver 30 is supplying the image data to the display panel 60, a blocking or masking is performed by maintaining the display state indicating signal DOS at a high level so that the output signal of the AND gate 31-1 is not output as the first reset signal New_RST, until after the blanking data is supplied to the display panel 60 for a predetermined number (N) of frames.

As illustrated in FIGS. 3 and 4, after the blanking data is supplied to the display panel 60 for a predetermined number (N) of frames, the logic level of the display state indicating signal DOS is switched to a logic low level. Accordingly, the selector 31-3 outputs the output signal of the AND gate 31-1 as the first reset signal New_RST.

When the display driver 30 receives the hardware reset signal HWRST in a state other than the display-on state during which the image data is supplied to the display panel 60, e.g., a sleep-in state and/or a power-on state, the selector 31-3 outputs the output signal of the AND gate 31-1 as the first reset signal New_RST since the display state indicating signal DOS is at a low level. At this time, the second reset signal Gen_RST maintains a high level, and thus the AND gate 31-1 outputs the same signal as the hardware reset signal HWRST.

The reset signal generation circuit 33 may output a control signal to reset the display control register 41 and the power control register 45 based on the first reset signal New_RST and a power-on reset signal (POR). The power-on reset signal (POR) is output from the host 20 when the display panel 60 operates in a power-on state, as opposed to a display-on state. That is, when the display panel 60 is not displaying image data and is not operating in a sleep-in state, the POR signal is generated. The reset signal generation circuit 33 may be implemented as an AND gate.

The FSM 35 may be used to provide a predefined sequence to the display driver 40. For example, the FSM 35 controls the display panel 60 to enter into a display-on state, a normal display state, a blanking display state, a power-on state and/or a sleep-in state, according to the control signals or commands output from the host 20. The display-on state may denote an operational state (or mode) in which the image data, such as a still image and/or moving image and/or blank data, can be supplied to the display panel 60, the normal display state may denote an operational state (or mode) in which, for example, a still image and/or a moving image, is being displayed on the display panel 60, the blanking display state denotes an operational state (or mode) in which the blanking data is supplied to the display panel 60, the sleep-in state denotes a sleep state (or mode) in which power is inhibited to the display panel 60, and the power-on state denotes a state (or mode) in which power is delivered to the display panel 60.

The FSM 35 includes a combinational logic 37 and a plurality of registers 36. The combinational logic 37 outputs state control signals to control an operational state of the display panel 60 to the plurality of registers 36, in response to state information output from the plurality of registers 36 and control signals or commands output from the host 20.

The plurality of registers 36 may control an operation of the first control logic 39 and/or an operation of the second control logic 43 in response to the state control signals output from the combinational logic 37. The FSM 35 may be in electrical communication with the reset signal generation circuit 33 to receive the POR signal. Each of the plurality of registers 36 may be implemented as a D-flip-flop and may be initiated in response to the power-on reset signal POR. In other words, the FSM 35 may be initiated in response to the power-on reset signal POR.

The first control logic 39 may output control signals to control an operation of the source driver 47 and an operation of the gate driver 49, in response to control signals or commands output from the host 20 and the state control signals output from the FSM 35.

The display control register 41 may output signals to control the operations of the source driver 47 and the gate driver 49, in response to the control signals output from the first control logic 39 and a clock signal CLK. The display control register 41 may be implemented as at least one D-flip-flop and may be initiated when an output signal of the reset signal generation circuit 33 is in a low level.

The second control logic 43 outputs power control signals to control power supplied to at least one of the source driver 47, the gate driver 49, and the display panel 60, in response to the control signals or commands output from the host 20 and the state control signals output from the FSM 35.

The power control register 45 may store information relating to a state of the power supplied to display panel 60 to control the power supplied to at least one of the source driver 47, the gate driver 49, and the display panel 60, in response to the power control signals output from the second control logic 43 and the clock signal CLK. The power control register 45 may be implemented as at least one D-flip-flop and may be initiated when the output signal of the reset signal generation circuit 33 is in a low level.

The source driver 47 drives a plurality of data lines (or a plurality of source lines) formed in the display panel 60 in response to the information output from the display control register 41 and a voltage output from the power supply block 51 so as to supply image data, such as still image data and/or moving image data, blanking data, and/or sleep data to the display panel 60.

Under the control of the timing controller 40, when the hardware reset signal HWRST is applied from the host 20 while the image data is being supplied to the display panel 60, the source driver 47 supplies the blanking data instead of the image data to the display panel 60 for a predetermined number (N) of frames. The gate driver 49 sequentially drives a plurality of gate lines (or a plurality of scan lines) formed in the display panel 60 in response to the output from the display control register 41 and the voltage output from the power supply block 51. The power supply block 51 controls the power supplied to at least one of the source driver 47, the gate driver 49, and the display panel 60, based on the state information stored in the power control register 45.

The display panel 60, which may be implemented into a flat display panel, includes a plurality of data lines, a plurality of gate lines, and a plurality of pixels formed at intersections of the data lines and the gate lines.

When the source driver 47 supplies the blanking data to the display panel 60, signals having identical voltage levels are stored in storage capacitors formed in the plurality of pixels, and thus an afterimage does not remain on the display panel 60 due to the blanking data, even when the hardware reset signal HWRST is applied while the image data is being supplied to the display panel 60.

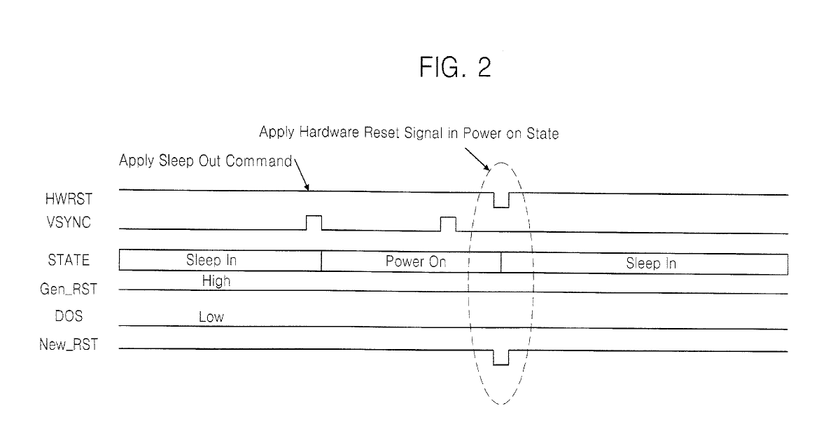

FIG. 2 is a timing diagram of the control signals to control the operation of the display driver 30 when the hardware reset signal (HWRST) is applied in a non display-on state, i.e., a state other than the display-on state. The operation of the display driver 30 in the non display-on state will now be described with reference to FIGS. 1 and 2.

The hardware reset signal (HWRST) is output from the host 20. A vertical synchronization signal is denoted by VSYNC. A display state (STATE) of the display panel 60 switches from a sleep-in state to a power-on state according to a sleep-out command output from the host 20. Thus, the display driver 30 performs a power-on sequence to initialize the display panel 60 into a power-on state, and the power-on reset signal (POR) is generated. Additionally, since the panel display 60 is operating in a non display-on state, i.e., a power-on state, the DOS signal is low.

When the hardware reset signal HWRST is generated in the power-on state, the AND gate 31-1 outputs the same signal as the hardware reset signal HWRST, since the Gen_RST signal and New_RST signal are each high. Accordingly, the selector 31-3 outputs the output signal of the AND gate 31-1 as the first reset signal New_RST, since the DOS signal is low. At this time, the POR signal and the first reset signal New_RST are both input to the reset signal generation circuit 33. As a result, the reset signal generation circuit 33 generates a control signal that may initiate the display control register 41 and the power control register 45.

After the reset signal generation circuit 33 outputs the control signal, the hardware reset signal HWRST becomes low active. If the panel display 60 operates in a state other than the display-on state, such as a sleep-in state and/or a power-on state, when the hardware reset signal HWRST is generated, the reset signal generation circuit 33 generates the first reset signal New_RST almost simultaneously with the generation of the hardware reset signal HWRST. Thus, the display panel 60 enters into the sleep-in state.

FIG. 3 is a timing diagram of the control signals to control the operation of the display driver 30 when the hardware reset signal HWRST is applied in the display-on state, for example, the normal display state and/or the blanking display state.

Referring to FIGS. 1 and 3, when the hardware reset signal HWRST is applied from the host 20 to the display driver 30 in the display-on state, the display driver 30 may supply the blanking data to the display panel 60 for a predetermined number (N) of frames. At this time, the display state indicating signal DOS maintains a high level while the blanking data is being supplied to the display panel 60 during the blanking display state. Accordingly, the selector 31-3 outputs a signal having a high level as the first reset signal New_RST to the reset signal generation circuit 33. However, since the display panel 60 is operating in a display-on state, as opposed to a power-on state, the power-on reset signal (POR) is not generated. As a result, the output of the reset signal generation circuit 33 is low. That is, since the reset signal generation circuit 33 does not receive the POR signal, the reset signal generation circuit does not output a control signal in a high state, such that the display control register 41 and the power control register 45 are not initiated.

After supplying the blanking data for a predetermined number (N) of frames, the display panel 60 is switched into the sleep-in mode, and the logic level of the display state indicating signal DOS transits to a logic low level, thereby indicating that the display panel 60 is no longer operating in a display-on state. After the display state indicating signal DOS transits to a logic low level, the second reset signal Gen_RST maintains a low level for a predetermined period of time before transitioning to a high level as illustrated in FIG. 3. As a result, the selector 31-3 outputs the output signal of the AND gate 31-1 as the first reset signal New_RST, and thus the reset signal generation circuit 33 outputs the control signal capable of initiating the display control register 41 and the power control register 45, in response to receiving both the power-on reset signal POR and the first reset signal New_RST.

In other words, the reset control circuit 31 of the display driver 30 generates the first reset signal New_RST after the blanking data is supplied to the display panel 60 for a predetermined number (N) of frames and after the generation of the hardware reset signal HWRST. Thus, although the hardware reset signal HWRST is generated in the display-on state while image data is displayed, the blanking data may be supplied to the display panel 60 for a predetermined number (N) of frames, and thus generation of an afterimage on the display panel 60 may be prevented.

FIG. 4 is a timing diagram of data output from the display driver 30 to the display panel 60 and the control signals to control the operation of the display driver 30, when the hardware reset signal HWRST is applied in the display-on state.

Referring to FIGS. 1, 3, and 4, when the hardware reset signal HWRST is applied to the display driver 30 in a display-on state where normal data or normal image data, such as still image data and/or moving image data, is supplied to the display panel 60, a control block (not shown) of the display driver 30 activates a blanking enable signal BLK_EN to a high level in response to the hardware reset signal HWRST. While the blanking enable signal BLK_EN is maintaining an activated state, the source driver 47 of the display driver 30 supplies blanking data (or a blanking image) to the display panel 60.

The blanking data having identical grayscale voltages (for example, voltages having a white level or a black level) are supplied to all of the data lines formed in the display panel 60. An interval during which the blanking enable signal BLK_EN maintains an active state may be a predetermined number (N) of frames. Although a predetermined number of frames is an exemplary interval, other intervals may be utilized, including a predetermined time period (t).

After the blanking data is supplied to the display panel 60 for the predetermined interval, for example, N frames, the source driver generates sleep data, i.e., a signal having the lowest grayscale voltage level, that is supplied to all of the data lines formed in the display panel 60. Thus, the display panel 60 enters into the sleep-in state, and power to the display panel 60 may be inhibited such that the display of the display panel 60 may be turned off.

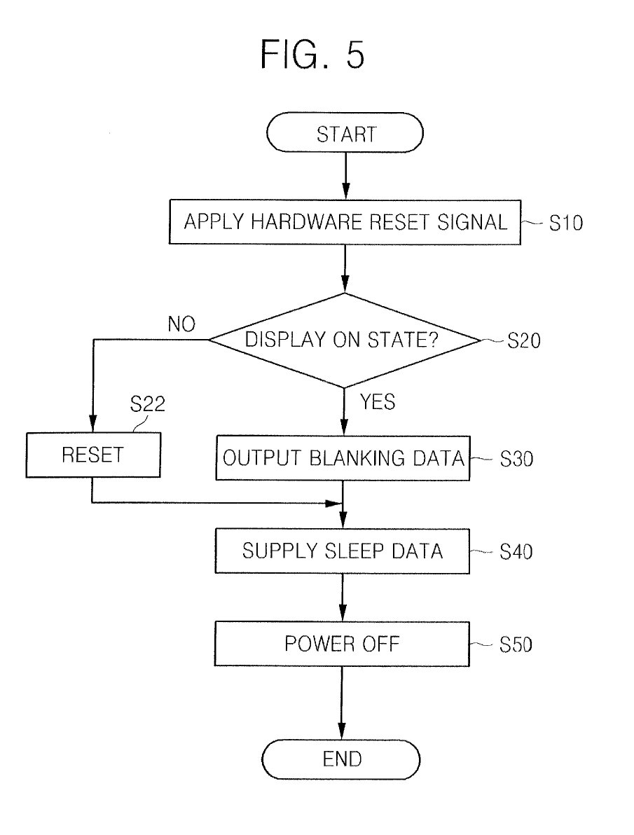

FIG. 5 is a flowchart of an operation of the display system 10 illustrated in FIG. 1. Referring to FIGS. 1 through 5, in operation S10, the hardware reset signal HWRST generated by the host 20 is applied to the display driver 30.

In operation S20, the timing controller 40 determines when to initiate each of the registers 41 and 45 according to the display state indicating signal DOS. As described above with reference to FIG. 2, since the display state indicating signal DOS maintains a high level in the display-on state and a low level in a non display-on state, i.e., a state other than the display-on state, when the hardware reset signal HWRST is applied in the power-on state of the display panel 60, the reset signal generation circuit 33 may initiate each of the registers 41 and 45 simultaneously when the hardware reset signal HWRST is applied, in operation S22. Thus, the display panel 60 enters into the sleep-in state. Accordingly, the display driver 30 may supply the sleep data to the display panel 60 in operation S40, and may inhibit supply of power to the display panel 60 in operation S50.

However, as described above with reference to FIGS. 3 and 4, when the hardware reset signal HWRST is applied in the display-on state, the display driver 30 supplies the blanking data to the display panel 60 for a predetermined number (N) of frames, in operation S30. Then, the display driver 30 may supply the sleep data to the display panel 60 in operation S40 and inhibit supply of power to the display panel 60 in operation S50. The operations S40 and S50 denote a sleep-in state of the display panel 60.

In a display driver and a display device including the display driver according to an exemplary embodiment of the present general inventive concept, even when a hardware reset signal is applied while image data is being displayed on a display panel, blanking data may be output to the display panel for a predetermined number of frames. Thus, an afterimage may be prevented from being generated on the display panel 60.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

1. A method of operating a display driver, the method comprising:
supplying image data to a display panel; and
supplying blanking data to the display panel in response to a reset signal applied while the image data is being supplied to the display panel.

2. The method of claim 1, wherein the blanking data is supplied to the display panel for a predetermined number (N) of frames in response to a blanking enable signal generated according to the reset signal, wherein N denotes a natural number.

3. The method of claim 1, wherein the blanking data is a set of data having identical levels.

4. The method of claim 1, further comprising supplying sleep data to the display panel, after supplying the blanking data to the display panel.

5. The method of claim 4, further comprising blocking supply of power to at least one the display driver or the display panel, after supplying the sleep data to the display panel.

6. A display driver comprising:
a gate driver to drive a display panel; and
a source driver to display image data on the display panel together with the gate driver,
wherein the source driver supplies blanking data to the display panel in response to a reset signal applied while the image data is being supplied to the display panel.

7. The display driver of claim 6, wherein the source driver supplies the blanking data to the display panel for a predetermined number (N) of frames in response to a blanking enable signal generated in response to the reset signal, wherein N denotes a natural number.

8. The display driver of claim 6, wherein the source driver supplies sleep data to the display panel after supplying the blanking data to the display panel.

9. The display driver of claim 6, further comprising a finite state machine (FSM) capable of being initiated in response to a power-on reset signal and controlling an operation of the source driver and an operation of the gate driver.

10. The display driver of claim 6, further comprising:
a display control register capable of being initiated in response to a power-on reset signal or a first reset signal and controlling an operation of the source driver and an operation of the gate driver; and
a power control register capable of being initiated in response to the power-on reset signal or the first reset signal and controlling supply of power to at least one of the source driver, the gate driver, or the display panel.

11. The display driver of claim 10, further comprising:
an AND gate to receive a second reset signal generated after the blanking data is supplied to the display panel and a hardware reset signal; and
a selector to output an output signal of the AND gate or a high level signal to serve as the first reset signal, in response to a display state indicating signal.

12. The display driver of claim 11, wherein the selector outputs the output signal of the AND gate or the high level signal to serve as the first reset signal, in response to the display state indicating signal that indicates whether the blanking data has been completely supplied to the display panel.

13. A display device comprising:
a display panel; and
a display driver to supply data to the display panel,
wherein the display driver supplies blanking data to the display panel for a predetermined number (N) of frames in response to a reset signal generated in a display-on state.

14. The display device of claim 13, wherein the display driver further comprises an FSM capable of being initiated in response to a power-on reset signal and controlling an operational state of the display driver.

15. The display device of claim 13, wherein the display driver further comprises:
a display control register capable of being initiated in response to a power-on reset signal or a first reset signal and controlling an operation of a source driver to drive a plurality of source lines formed in the display panel and an operation of a gate driver to drive a plurality of gate lines formed in the display panel; and
a power control register capable of being initiated in response to the power-on reset signal or the first reset signal and controlling supply of power to at least one of the source driver, the gate driver, or the display panel.

16. The display device of claim 15, wherein the display driver further comprises:
an AND gate to receive a second reset signal generated after the blanking data is supplied to the display panel for the N frames and a hardware reset signal; and
a selector to output an output signal of the AND gate or a high level signal to serve as the first reset signal, in response to a display state indicating signal.

17. The display device of claim 16, wherein the selector outputs the output signal of the AND gate or the high level signal to serve as the first reset signal, in response to the display state indicating signal that indicates whether the blanking data has been completely supplied to the display panel.

18. A display system comprising:
a display device; and
a processor to control an operation of the display device,
wherein the display device comprises:
a display panel; and
a display driver to supply data output from the processor to the display panel,
wherein the display driver supplies blanking data to the display panel in response to a reset signal output from the processor in a display-on state.

19. The display system of claim 18, wherein the display driver supplies the blanking data to the display panel for a predetermined number (N) of frames in response to a blanking enable signal generated in response to the reset signal, wherein N denotes a natural number.

20. The display system of claim 20, wherein the display driver supplies sleep data to the display panel after supplying the blanking data to the display panel.

21.-27. (canceled)
